(19) United States
(12) Patent Application Publication
(10) Pub. No.: US 2014/0050840 A1
(43) Pub. Date: Feb. 20, 2014

(54) Manufacturing Method for Touch Screen Panel

(71) Applicant: Enjet Co. Ltd., Suwon-si (KR)

(72) Inventor: Do-Young Byun, Seoul (KR)

(73) Assignee: Enjet Co. Ltd., Suwon-si (KR)

(21) Appl. No.: 13/964,602

(22) Filed: Aug. 12, 2013

(30) Foreign Application Priority Data
Aug. 14, 2012 (KR) 10-2012-0089127

(51) Int. Cl. G02F 1/1333

(52) U.S. Cl. CPC G02F 1/13338
USPC 427/122; 427/58; 427/123; 427/125

(57) ABSTRACT

A method for manufacturing a touch screen panel includes forming a basic pattern of patterning first electrodes along a first direction on a substrate, second electrodes along a second direction crossing the first direction, and a first connecting pattern connecting the first electrodes, forming insulating layers of patterning insulating layers over the first connecting pattern, and forming a second connecting pattern of patterning a second connecting pattern in an electrohydrodynamic (EHD) ink jetting type such that the second connecting pattern connecting the second electrodes pass over the insulating layers.

### CROSS-REFERENCE TO RELATED APPLICATIONS

This application claims the benefit of priority under 35 U.S.C. §§119 and 371 of Korean Patent Application No. 10-2012-0089127, filed on Aug. 14, 2012, in the Korean Intellectual Property Office, the entire disclosure of which is incorporated herein by reference for all purposes.

### STATEMENT REGARDING FEDERALLY SPONSORED RESEARCH OR DEVELOPMENT

Not Applicable

### FIELD OF THE INVENTION

The present invention lies in the field of touch screen panels. The present disclosure relates to a method for manufacturing a touch screen panel, for example, a method for manufacturing a touch screen panel capable of simplifying a process of patterning a connecting pattern or electrodes of a touch screen panel by using an electrohydrodynamic (EHD) ink jetting type without performing an evaporating or etching process.

### BACKGROUND OF THE INVENTION

When an object or a person's hand touches a particular letter or position on a touch screen without using an input apparatus such as a keyboard or mouse etc., the touch screen locates the object or the persons' hand and processes certain functions accordingly. Thus, since the user may directly touch and manipulate the screen, there are advantages of high efficiency and convenience of manipulating.

With the recent advent of smart phones, touch screens are becoming more important and are emerging as a new trend in not only the mobile market but also in portable device markets such as MP3, portable game, and navigation, and even washing machine and refrigerator markets etc.

There are two types of touch screens depending on the method of sensing a touched portion: resistive-type and capacitance-type. A resistive-type touch screen has a structure where two substrates coated with Indium Oxide (In₂O₃: ITO) are distanced from each other, and when these two substrates contact each other due to a pressure applied, the touch screen senses the change of voltage and recognizes a location accordingly. On the other hand, in a capacitance-type touch screen, when an object approaches or touches the panel, the changed capacitance between the sensed electrodes embedded in the panel is measured to sense and recognize the approached or touched location.

In various conventional touch panels, transparent electrodes and indium oxide (ITO) are used as the main material of transparent electrodes. Herein, transparent electrodes perform evaporating processes such as sputtering to form a conductive layer, and form a pattern through wet etching.

However, this conventional method is costly since an evaporating process such as sputtering and an etching process need to be performed, and inside the chamber where these processes are performed needs to be kept vacuous.

There are also problems such as increase of material cost of Indium which is the main material of transparent electrodes, instability of markets, depletion of material, and element deterioration due to spread of Indium etc.

Thus, a need exists to overcome the problems with the prior art systems, designs, and processes as discussed above.

### SUMMARY OF THE INVENTION

The invention provides a method for manufacturing a touch screen panel that overcomes the hereinafore-mentioned disadvantages of the heretofore-known devices and methods of this general type and that is capable of forming a pattern in a simple method without having to repeat an evaporating process or etching process to form a pattern, thereby reducing the cost.

The present disclosure resolves the aforementioned conventional problems, that is, to provide a method for manufacturing a touch screen panel.

In addition, by the aforementioned method, it is possible to pattern electrodes of a thin line width by discharging a jetting solution in an electrohydrodynamic (EHD) ink jetting type.

Furthermore, it is possible to form an insulating layer having the size of a dot by discharging a low viscosity jetting solution in an electrohydrodynamic (EHD) ink jetting type.

In addition, since Indium Oxide is not used in patterning electrodes or a connecting pattern according to the present method, it is possible to reduce the manufacturing cost.

In one general aspect, there is provided a method for manufacturing a touch screen panel, the method comprising: a basic pattern of patterning first electrodes along a first direction on a substrate, second electrodes along a second direction crossing the first direction, and a first connecting pattern connecting the first electrodes; forming insulating layers of patterning insulating layers over the first connecting pattern; and forming a second connecting pattern of patterning a second connecting pattern in an electrohydrodynamic (EHD) ink jetting type such that the second connecting pattern connecting the second electrodes pass over the insulating layers.

In the general aspect, the method may further comprise forming a third connecting pattern of patterning a third connecting pattern connecting the first electrodes or second electrodes with a touch controller for transmitting signal information generated in the first electrodes or second electrodes, after the forming a basic pattern.

In the general aspect, a jetting solution having a viscosity of 1000 cP or less may be used to pattern the insulating layers between the first connecting pattern and second connecting pattern by dots or patterns of micro or nanometer scale areas preventing contact between the first connecting pattern and second connecting pattern.

In the general aspect, the forming insulating layers may be made by a drop-on-demand type.

In the general aspect, the electrohydrodynamic (EHD) ink jetting type may be one of a drop-on-demand type of patterning by jetting a jetting solution in liquid droplets or a sequential jet type of patterning by sequential jetting through electrospinning of a jetting solution, and the first electrodes, second electrodes or third connecting pattern may be patterned by the sequential jet type or drop-on-demand type.

In the general aspect, when patterning the second connecting pattern or third connecting pattern in a sequential jet type, the substrate may be disposed within a straight jet flow section of the jetting solution being jet by the electrospinning.

In the general aspect, a jetting solution having a viscosity of 1000 cP or less may be used to pattern the second connecting pattern or third connecting pattern.

In the general aspect, the third connecting pattern may be patterned to have a line width of 50 μm or less.

In the general aspect, the second connecting pattern or third connecting pattern may patterned to have a line width of 10 μm or less.

In the general aspect, the third connecting pattern may be patterned by one of a lithography type, gravure printing type, offset printing type, gravure-offset printing type, or flexo printing method.

In the general aspect, the jetting solution used in patterning the second connecting pattern may be one of a metal material, an inorganic conductive material, and an organic conductive material.

In the general aspect, the material of the jetting solution may comprise at least one of Au, Ag, Ag nano wire, Al, Cu, carbon nano tube (CNT), Graphene and Polyethylenedioxythiophene (PEDOT).

In the general aspect, the jetting solution may further comprise a natural polymer or synthetic polymer so as to adjust a viscosity of the jetting solution.

In the general aspect, the natural polymer may comprise at least one of chitosan, gelatin, collagen, elastin, hyaluronic acid, cellulose, silk fibroin, phospholipids, and fibrinogen.

In the general aspect, the synthetic polymer may comprise at least one of PLGA(Poly(lactic-co-glycolic acid)), PLA(Poly(lactic acid)), PHBV(Poly(3-hydroxybutyrate-hydroxyvalerate), PDO(Polydioxanone), PGA(Polyglycolic acid), PLCL(Poly(e-caprolactone-co-lactide)), PCL(Poly(e-caprolactone)), PLLA(Poly-L-lactic acid), PEUU(Poly(ether Urethane Urea), Cellulose acetate), PEG(Polyethylene glycol), EVOH(Poly(Ethylene Vinyl Alcohol), PVA(Polyvinyl alcohol), PEO(Polyethylene glycol) and PVP(Polyvinylpyrrolidone).

In the general aspect, the electrode where the basic pattern is patterned may be transferred along the second direction crossing the first direction, at the forming insulating layers, the insulating layers may be patterned by a jetting solution being jetted from a first fixed nozzle disposed along the direction the substrate is transferred on the substrate, at the forming second electrodes, the second connection pattern may be patterned by a jetting solution being jetted from a second fixed nozzle disposed to be distanced from the first fixed nozzle in an opposite direction to the direction the substrate is transferred, and the insulating layers and second connecting pattern may be sequentially patterned by a roll process.

In another general aspect, there is provided a method for manufacturing a touch screen panel, the method comprising forming first electrodes of patterning a plurality of first electrodes to be distanced from one another along a first direction by an electrohydrodynamic (EHD) ink jetting type; forming insulating layers of patterning a plurality of insulating layers to be distanced from one another along the first electrodes by an electrohydrodynamic (EHD) ink jetting type; and forming second electrodes wherein a plurality of first electrodes are distanced from one another along a first direction by an electrohydrodynamic (EHD) ink jetting type.

In the general aspect, the method may further comprise forming a third connecting pattern of patterning a third connecting pattern connecting the first electrodes or second electrodes with a touch controller for transmitting signal information generated in the first electrodes or second electrodes, after the forming second electrodes.

In the general aspect, a jetting solution having a viscosity of 1000 cP or less is used to pattern the insulating layers between the first electrodes and second electrodes by dots or patterns of micro or nanometer scale areas preventing contact between the first electrodes and second electrodes.

In the general aspect, the forming insulating layers may be patterned by the drop-on-demand type.

In the general aspect, the third connecting pattern may be patterned by one of a lithography type, gravure printing type, offset printing type, gravure-offset printing type, or flexo printing method.

In the general aspect, the electrohydrodynamic (EHD) ink jetting type may be one of a drop-on-demand type of patterning by jetting a jetting solution in liquid droplets or a sequential jet type of patterning by sequential jetting through electrospinning of a jetting solution, and the first electrodes, second electrodes or third connecting pattern may be patterned by the sequential jet type or drop-on-demand type.

In the general aspect, when patterning the first electrodes or second electrodes in a sequential jet type, the substrate may be disposed within a straight jet flow section of the jetting solution being jet by the electrospinning.

In the general aspect, a jetting solution having a viscosity of 1000 cP or less may be used to pattern the first electrodes or second electrodes.

In the general aspect, a jetting solution having a viscosity of 1000 cP or less may be used to pattern the first electrodes or second electrodes in the drop-on-demand type.

In the general aspect, the third connecting pattern may be patterned to have a line width of 50 μm or less.

In the general aspect, the first electrodes, second electrodes or third connecting pattern may be patterned to have a line width of 10 μm or less.

In the general aspect, a jetting solution having a viscosity of 1000 cP or less may be used to pattern the first electrodes or second electrodes.

In the general aspect, the jetting solution used in patterning the first electrodes and second electrodes may be one of a metal material, an inorganic conductive material, and an organic conductive material.

In the general aspect, the material of the jetting solution may comprise at least one of Au, Ag, Ag nano wire, Al, Cu, carbon nano tube (CNT), Graphene and Polyethylenedioxythiophene (PEDOT).

In the general aspect, the jetting solution may further comprise a natural polymer or synthetic polymer so as to adjust a viscosity of the jetting solution.

In the general aspect, the natural polymer may comprise at least one of chitosan, gelatin, collagen, elastin, hyaluronic acid, cellulose, silk fibroin, phospholipids, and fibrinogen.

In the general aspect, the synthetic polymer may comprise at least one of PLGA(Poly(lactic-co-glycolic acid)), PLA(Poly(lactic acid)), PHBV(Poly(3-hydroxybutyrate-hydroxyvalerate), PDO(Polydioxanone), PGA(Polyglycolic acid), PLCL(Poly(e-caprolactone-co-lactide)), PCL(Poly(e-caprolactone)), PLLA(Poly-L-lactic acid), PEUU(Poly(ether Urethane Urea), Cellulose acetate), PEG(Polyethylene glycol), EVOH(Poly(Ethylene Vinyl Alcohol), PVA(Polyvinyl alcohol), PEO(Polyethylene glycol) and PVP(Polyvinylpyrrolidone).

In the general aspect, the substrate where the first electrodes are patterned may be transferred along the second direction, at the forming insulating layers, the insulating layers may be patterned by a jetting solution being jetted from a first fixed nozzle disposed along the direction the substrate is transferred on the substrate, at the forming second electrodes, the second electrodes may be patterned by a jetting solution being jetted from a second fixed nozzle disposed to be distanced from the first fixed nozzle in an opposite direction to the direction the substrate is transferred, and the insulating layers and second electrodes may be sequentially patterned by a roll process.

According to the method for manufacturing a touch screen panel of present disclosure, a pattern may be formed through a simple process without or minimized evaporating process and etching process, thereby reducing the patterning cost.

In addition, it is possible to adjust the line width of the electrodes to micrometer or nanometer units using electrohydrodynamic (EHD) ink jetting type, thereby resolving visibility problem of patterns.

Furthermore, it is possible to embody fine line widths, thereby minimizing an bezel area of an apparatus using a touch screen.

Although the invention is illustrated and described herein as embodied in a method for manufacturing a touch screen panel, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

FIG. 1 is a top plan view roughly illustrating a touch screen panel manufactured by a method for manufacturing a touch screen panel according to a first exemplary embodiment of the present disclosure;

FIG. 1A is fragmentary, enlarged portion of the touch screen panel of FIG. 1;

FIG. 2 is a top plan view roughly illustrating a touch screen panel manufactured by a method for manufacturing a touch screen panel according to a second exemplary embodiment of the present disclosure;

FIG. 3 is a perspective view roughly illustrating a moving path of jetting solution discharged from a discharger during printing in an electrohydrodynamic (EHD) ink jetting type used in a method for manufacturing a touch screen panel according to the first exemplary embodiment of the present disclosure;

FIG. 4 is a perspective view roughly illustrating a direct jet flow of jetting solution used in a method for manufacturing a touch screen panel according to the first exemplary embodiment of the present disclosure in a printing by the electrohydrodynamic (EHD) ink jetting type of FIG. 3;

FIG. 5 is a flowchart roughly illustrating a method for manufacturing a touch screen panel according to the first exemplary embodiment of the present disclosure;

FIG. 6A is a fragmentary, perspective view roughly illustrating a method for manufacturing a touch screen panel according to the first exemplary embodiment of the present disclosure for preparing a drop-on-demand type printing;

FIG. 6B is a fragmentary, perspective view roughly illustrating a method for manufacturing a touch screen panel according to the first exemplary embodiment of the present disclosure for forming an insulating layer over a first connecting pattern;

FIG. 6C is a fragmentary, perspective view roughly illustrating a method for manufacturing a touch screen panel according to the first exemplary embodiment of the present disclosure for patterning a second connecting pattern over the insulating layer;

FIG. 6D is a fragmentary, perspective view roughly illustrating a method for manufacturing a touch screen panel according to the first exemplary embodiment of the present disclosure where a patterning of a second connecting pattern is completed;

FIG. 7 is a fragmentary, perspective view roughly illustrating a case where a method for manufacturing a touch screen panel according to the first exemplary embodiment of the present disclosure is performed by a roll process;

FIG. 8 is a flowchart roughly illustrating a method for manufacturing a touch screen panel according to the second exemplary embodiment of the present disclosure;

FIG. 9A is a perspective view roughly illustrating a method for manufacturing a touch screen panel according to the second exemplary embodiment of the present disclosure for patterning a first electrode

FIG. 9B is a perspective view roughly illustrating a method for manufacturing a touch screen panel according to the second exemplary embodiment of the present disclosure for patterning an insulating layer over the first electrode

FIG. 9C is a perspective view roughly illustrating a method for manufacturing a touch screen panel according to the second exemplary embodiment of the present disclosure for patterning a second connecting pattern over the insulating layer;

FIG. 10 is a fragmentary, perspective view roughly illustrating performing a method for manufacturing a touch screen panel according to the second exemplary embodiment of the present disclosure by a roll process;

FIGS. 11A and 11B are photographs of patterning a second connecting pattern using a carbon nano tube in a method for manufacturing a touch screen panel according to the first exemplary embodiment of the present disclosure;

FIG. 12A is a photograph of a perspective view of patterning of a second connecting pattern using PEDOT in a method for manufacturing a touch screen panel according to the first exemplary embodiment of the present disclosure;

FIG. 12B is a photograph of a plan view of patterning of the second connecting pattern using PEDOT in a method for manufacturing a touch screen panel according to the first exemplary embodiment of the present disclosure;

FIG. 13 is a top plan view roughly illustrating a touch screen panel manufactured by the second exemplary embodiment of the present disclosure;

FIG. 14 is a perspective view roughly illustrating a touch screen panel manufactured by the second exemplary embodiment of the present disclosure; and

FIG. 15 is a photograph from above a touch screen panel manufactured by the second exemplary embodiment of the present disclosure provided over letters.

Throughout the drawings and the detailed description, unless otherwise described, the same drawing reference numerals will be understood to refer to the same elements, features, and structures. The relative size and depiction of these elements may be exaggerated for clarity, illustrating, and convenience.

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

Hereinbelow is detailed explanation on a method for manufacturing a touch screen panel (S100) according to a first exemplary embodiment of the present disclosure with reference to the attached drawings.

Prior to explaining a method for manufacturing a touch screen panel according to the present exemplary embodiment, a touch screen panel 100 manufactured by a first exemplary embodiment of the present disclosure (S100) is explained.

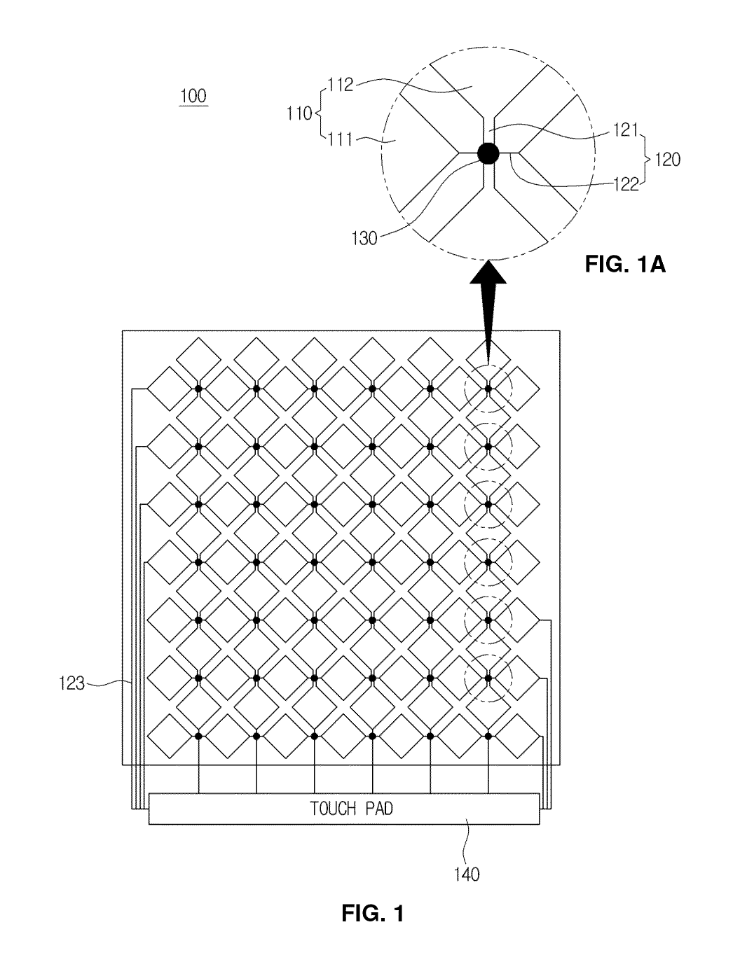

Described now are exemplary embodiments of the present invention. Referring now to the figures of the drawings in detail and first, particularly to FIG. 1, there is shown a top view roughly illustrating a touch screen panel manufactured by a method for manufacturing a touch screen panel according to a first exemplary embodiment of the present disclosure.

With reference to FIG. 1, the touch screen panel 100 manufactured by the first exemplary embodiment of the present disclosure (S100) includes electrodes 110, connecting pattern 120, insulating layer 130, and touch controller 140.

The electrode 110 is what makes a touch recognition. It includes a plurality of first electrodes 110 disposed to neighbor one another in a horizontal direction and a plurality of second electrodes 112 disposed to neighbor one another in a vertical direction. Meanwhile, a pattern shape of the electrode 110 may be, but is not limited to, a polygonal shape, such as a triangle and square or a circular shape. In addition, to minimize an evaporation process and etching process, it is desirable that the first electrode 111, the second electrode 112, and a first connecting pattern 121 to be explained hereinbelow are patterned in a same process.

The first electrode 111 recognizes a touch with the electrode connected along a horizontal direction and transmits signal information to the touch controller through a third connecting pattern 123 disposed in a leftmost side or rightmost side and is connected to the touch controller 140 to be explained hereinbelow.

The second electrode 112 recognizes a touch with the electrode 110 connected along a vertical direction and transmits a signal to the touch controller 140 through the third connecting pattern 123 formed in a lowermost side and connected to the touch controller 140 to the explained hereinbelow.

The connecting pattern 120 is an element provided between each electrode and connects each electrode so that a signal may be transmitted, or an element which connects the electrode with the touch controller 140 to be explained hereinbelow. The connecting pattern 120 includes a first connecting pattern 121 that connects each first electrode 111, a second connecting pattern 122, which connects each second electrode 112, and a third connecting pattern 123, which connects the first electrode 111 or second electrode 112 with the touch controller 140.

The first connecting pattern 121 connects each first electrode 111, and the second connecting pattern 122 connects each second electrode 112. Meanwhile, it is desirable that the first connecting pattern 121 is patterned in a same process as the first electrode 111 and second electrode 112. In addition, the first connecting pattern 121 and the second connecting pattern 122 must not contact each other so that signals generated in the first electrode 111 or the second electrode 112 are not electrically connected, and an insulating layer 130 is formed between the first connecting pattern 121 and second connecting pattern 122, which will be explained hereinbelow.

The third connecting pattern 123 is an element that connects the first electrode 111 or the second electrode 123 with the touch controller 140 to be explained hereinbelow so that a signal transmitted through the first electrode 111 or the second electrode 112 is transmitted to the touch controller 140. The portion connected from the first electrode 111 to the touch controller 140, and the portion connected from the second electrode 112 to the touch controller 140 is connected from the second electrode 112 provided in a lower end to the touch controller 140.

Meanwhile, it is possible to minimize a bezel area of an apparatus using a touch screen panel 100 by the present disclosure to maximize a liquid crystal portion by patterning a line width of the connecting pattern 120 μm to 10 μm or less so as not to be recognized visually from outside, and, particularly, by patterning a line width of the third connecting pattern 123 μm to 50 μm or less. Furthermore, as in FIG. 1, by patterning a line width of the third connecting pattern 123 to 10 μm or less so as not to be recognized visually from outside, it is possible to manufacture a touch screen panel that does not have a bezel area.

Meanwhile, the second connecting pattern 122 includes at least one material of among a metal material, inorganic conductive material, and organic conductive material, and, preferably, by using a jetting solution comprising a material selected from a group consisting of Au, Ag, Ag nano wire, Al, Cu, carbon nanotube (CNT), Graphene, conductive high molecule PEDOT, or a combination thereof, minimizes usage of Indium.

Meanwhile, to adjust a viscosity of the jetting solution, it is possible to mix a natural polymer or synthetic polymer.

Herein, a natural synthetic includes at least one of, but is not limited to, chitosan, gelatin, collagen, elastin, hyaluronic acid, cellulose, silk fibroin, phospholipids, and fibrinogen, or a combination thereof.

In addition, a synthetic polymer includes at least one of, but is not limited to, PLGA(Poly(lactic-co-glycolic acid)), PLA(Poly(lactic acid)), PHBV(Poly(3-hydroxybutyrate-hydroxyvalerate), PDO(Polydioxanone), PGA(Polyglycolic acid), PLCL(Poly(e-caprolactone-co-lactide)), PCL(Poly(e-caprolactone)), PLLA(Poly-L-lactic acid), PEUU(Poly(ether Urethane Urea), Cellulose acetate), PEG(Polyethylene glycol), EVOH(Poly(Ethylene Vinyl Alcohol), PVA(Polyvinyl alcohol), PEO(Polyethylene glycol) and PVP(Polyvinylpyrrolidone), or a combination thereof.

The insulating layer 130 is an element for preventing contact between the first connecting pattern 121 and the second connecting pattern 122 so that there is no electrical connection between the first connecting pattern 130 and the second connecting pattern 122. It is desirable to pattern the insulating layer 130 in a pattern having an area of a dot shape, micro or nano scale so as not to be visually recognized from outside.

Meanwhile, the jetting solution used in patterning the insulating layer 130 may be, but is not limited to, polyimide, polymethyl methacrylate (PMMa), polyurethane (PU), or SiO₂ etc. and any polymer material or organic or inorganic material having an insulating characteristic may be used.

The touch controller 140 is an element configured to receive a signal that is transmitted as a touch is recognized at the electrode 110 and then to process the received signal, but such a touch controller 140 is a well-known technology and, thus, detailed explanation is omitted.

Meanwhile, the aforementioned electrode 110, connecting pattern 120, and insulating layer 130 are patterned on a substrate, the substrate being, but is not limited to, a surface or both surfaces of glass or film.

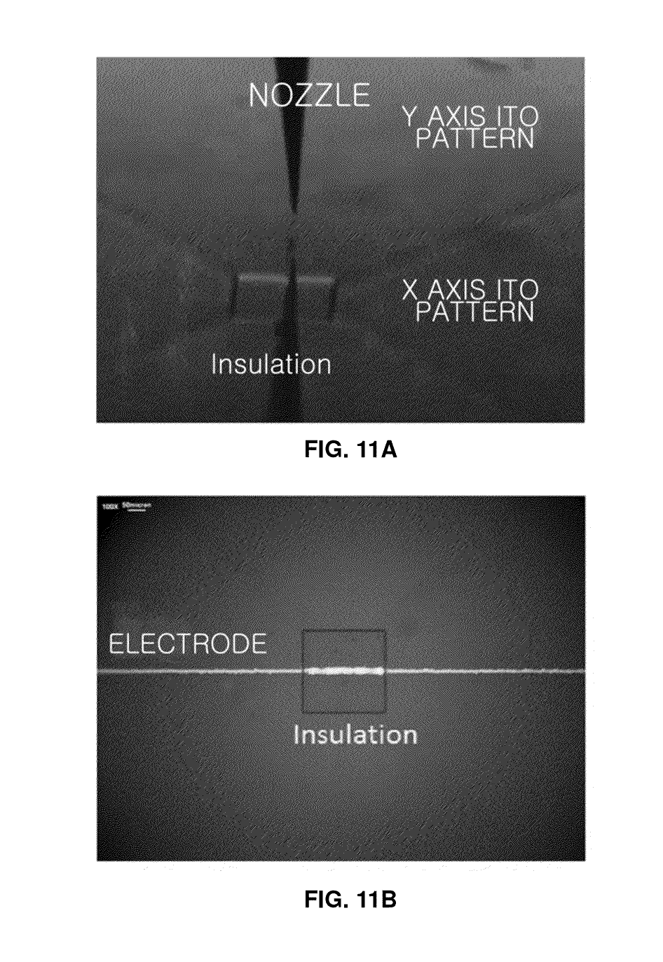

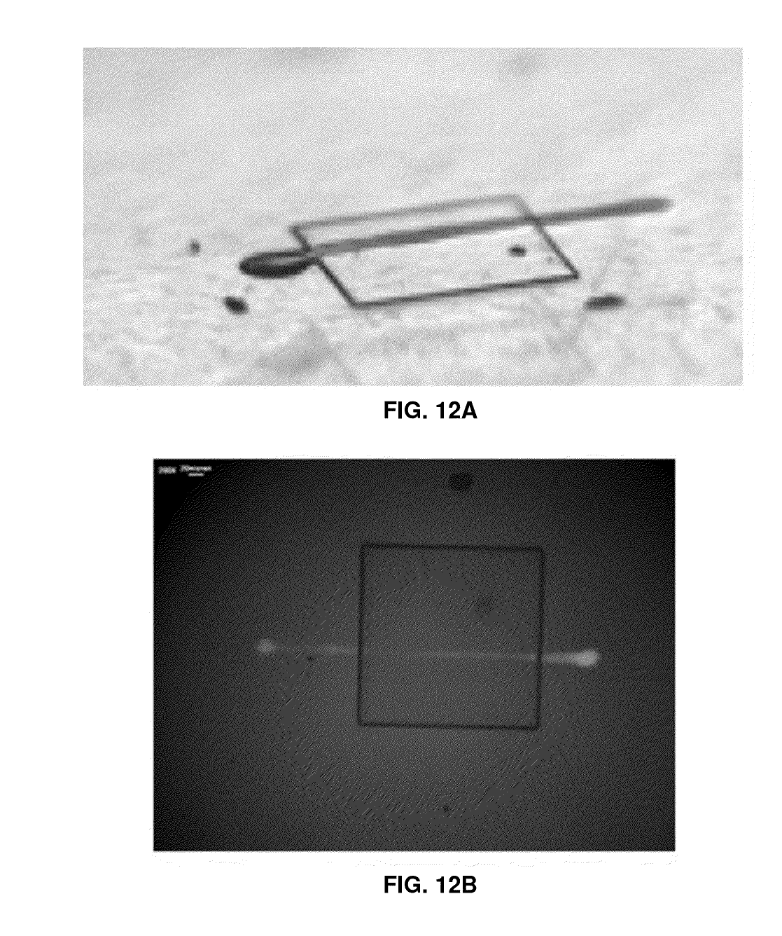

Herein, with reference to FIGS. 11 to 12, there can be seen a touch screen panel 110 manufactured by a first exemplary embodiment of the present disclosure (S100). FIG. 11 is a photograph of a second connecting pattern patterned using a carbon nanotube in a method for manufacturing a touch screen panel according to a first exemplary embodiment of the present disclosure, and FIG. 12 is a photograph of a second connecting pattern patterned using PEDOT in a method for manufacturing a touch screen panel according to a first exemplary embodiment of the present disclosure. FIG. 11 is a photograph of a second connecting pattern 122 patterned using a carbon nanotube (CNT), wherein the second connecting pattern 122 connecting a second electrode 112 expressed in a Y axis ITO pattern is patterned in an upper side of the insulating layer.

With reference to FIGS. 12A and 12B, the same process as in the aforementioned FIG. 12 is performed using PEDOT. That is, with reference to FIG. 11 or FIG. 12, it can be seen that a line width of the second connecting pattern 122 differs due to a type of a jetting solution, more particularly due to a viscosity of a jetting solution.

Hereinbelow is explanation on a manufacturing method of a first exemplary embodiment (S100) of a method for manufacturing the aforementioned touch screen panel. First of all, in the first exemplary embodiment (S100) of the method for manufacturing the touch screen panel, an electrohydrodynamic (EHD) ink jetting type may be one of a drop-on-demand type of patterning by jetting a jetting solution in liquid droplets or a sequential jet type of patterning by sequential jetting through electrospinning of a jetting solution. Herein, the drop-on-demand electrohydrodynamic (EHD) ink jetting type is a printing method for jetting particles of a jetting solution having a low viscosity, only when necessary. By this method, it is possible to generate smaller liquid droplets than the size of the nozzle, and discharge liquid droplets of about 1 μm.

In the case of patterning in the sequential jet type, when a jetting solution is electrospinned by an electrohydrodynamic (EHD) ink jetting type method, the jetting solution moves along a straight jet path perpendicular to the nozzle within a certain range from the discharger where the jetting solution is discharged, and, outside this range, the jetting solution moves along a spinning jet path of a spiral or corn shape. That is, the user will be able to pattern the pattern that he/she wants if the substrate is disposed within the section corresponding to the straight get of the jetting solution.

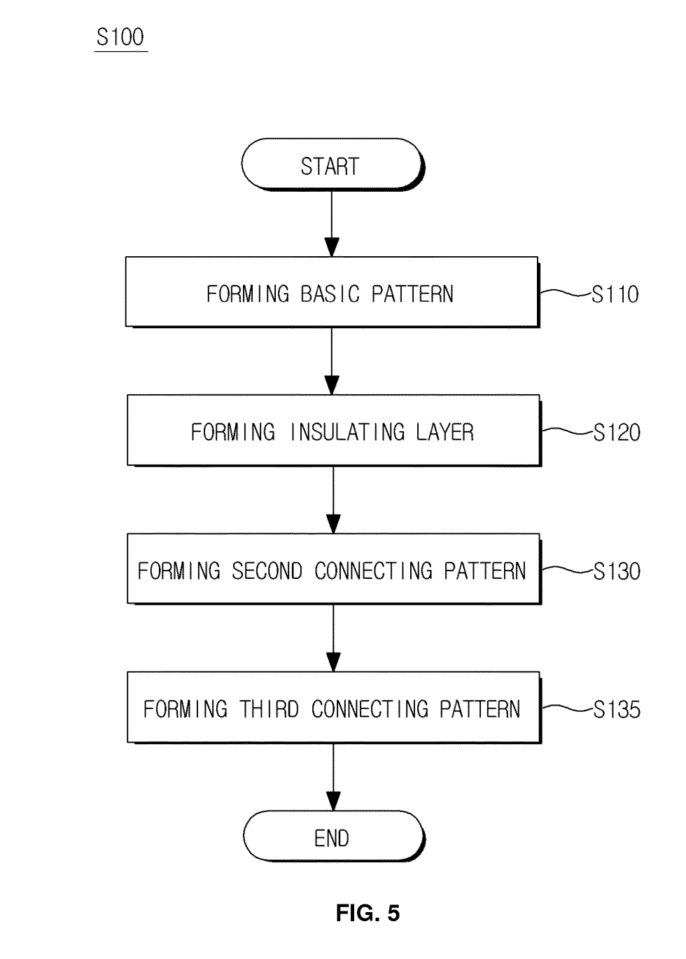

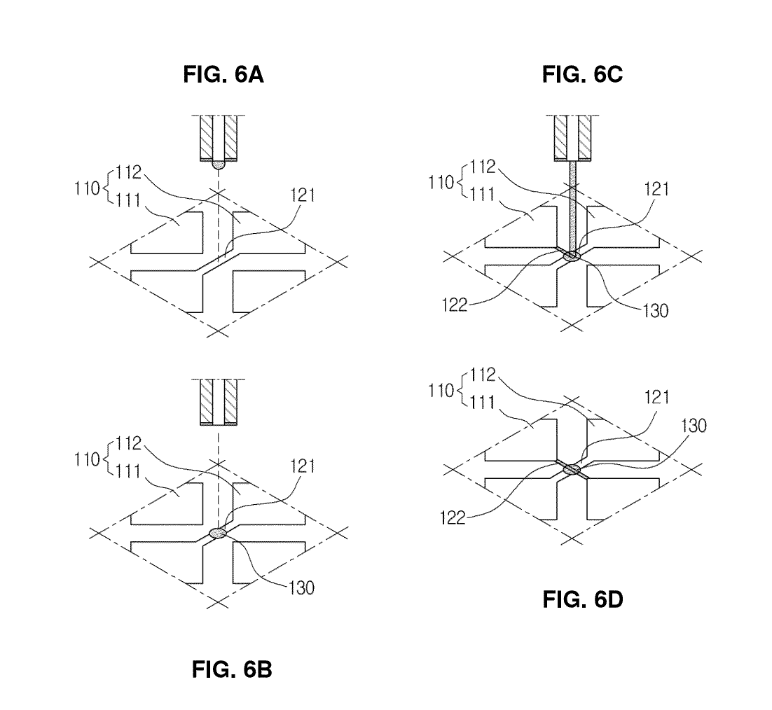

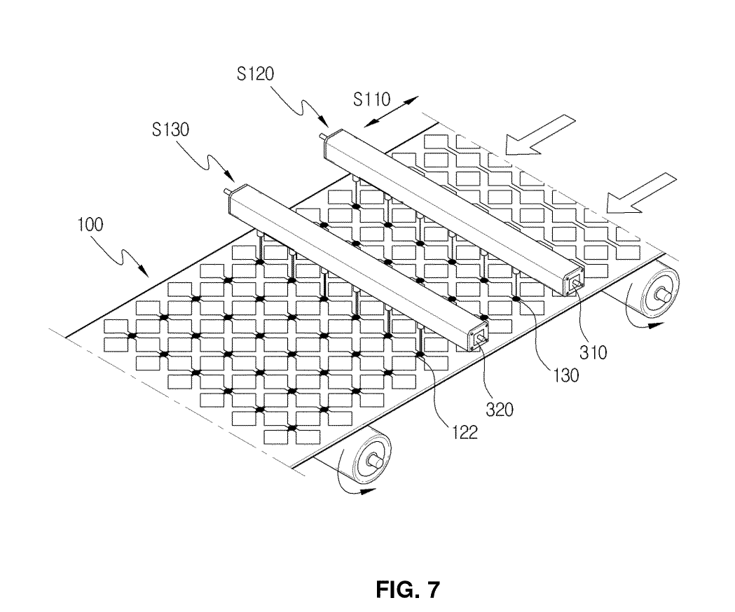

FIG. 5 is a flowchart roughly illustrating a method for manufacturing a touch screen panel according to the first exemplary embodiment of the present disclosure, FIGS. 6A to 6D are perspective views roughly illustrating a method for manufacturing a touch screen panel according to a first exemplary embodiment of the present disclosure, where FIG. 6A is a perspective view of preparing for a drop-on-demand type printing, FIG. 6B is a perspective view where insulating layers are formed over the first connecting pattern, FIG. 6C is a perspective view of patterning the second connecting pattern over the insulating layers, FIG. 6D is a perspective view of a completed patterning of the second connecting pattern, and FIG. 7 is a perspective view roughly illustrating a method for manufacturing a touch screen panel according to the first exemplary embodiment of the present disclosure by a roll process.

With reference to FIGS. 5 and 6, a method for manufacturing a touch screen panel according to a first exemplary embodiment of the present disclosure (S100) includes forming a basic pattern (S110), forming insulating layers (S120) and forming a second pattern (S130).

The forming a basic pattern (S110) is a step of patterning first electrodes 111, second electrodes 112, and a first connecting pattern 121 on a substrate (not illustrated). To simplify the process, it is desirable to pattern the first electrodes 111, second electrodes 112 and first connecting pattern 121 in the same process. The first electrodes 111, second electrodes 112 and first connecting pattern 121 may be patterned through an evaporating and etching process, but is not limited thereto. The first electrodes 111, second electrodes 112, and first connecting pattern 121 are made of Indium Oxide (In₂O₃), but are not limited thereto.

The forming insulating layers (S120) is a step of patterning insulating layers over the first connecting pattern 121 patterned at the step of forming a basic pattern (S110). As aforementioned, it is desirable that the insulating layers 130 are provided to prevent electrical connection between the first connecting pattern 121 and second connecting pattern 122, and it is desirable that the insulating layers 130 are minimized and patterned in a pattern of dots or patterns of micro or nanometer scale areas in order to prevent from being visually sensed outside. Therefore, when using a jetting solution of 1000 cP or less, more desirably, a jetting solution of 500 cP or less, for patterning in a drop-on-demand type, it would be possible to pattern the insulating layers 130 in a pattern of dots or patterns of micro or nanometer scale areas.

The forming a second connecting pattern (S130) is a step of patterning a second connecting pattern 112 that passes over the insulating layer 130 patterned at the step of forming insulating layers (S120) and connects each of the second electrode 112.

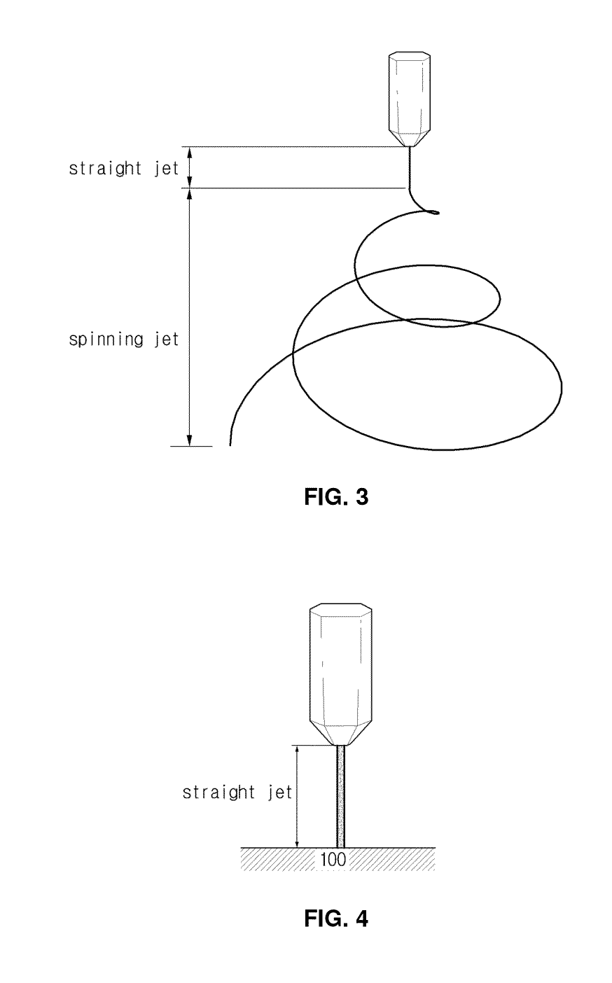

FIG. 3 is a perspective view roughly illustrating a moving path of a jetting solution discharged from a discharger when printing in an electrohydrodynamic (EHD) ink jetting type used in a method for manufacturing a touch screen panel according to a first exemplary embodiment of the present disclosure, and FIG. 4 is a perspective view roughly illustrating a straight jet flow of a jetting solution used in a method for manufacturing a touch screen panel according to a first exemplary embodiment of the present disclosure in a printing by an electrohydrodynamic (EHD) ink jetting type of FIG. 3. First of all, a process of patterning a second connecting pattern 122 in an electrohydrodynamic (EHD) ink jetting type is explained hereinbelow with reference to FIGS. 3 and 4. The second connecting pattern 122 may be patterned by an electrohydrodynamic (EHD) ink jetting type, more particularly, a drop-on-demand type or sequential jet type. In the case of a drop-on-demand type, it is desirable that a jetting solution has a viscosity of 1000 cP or less, and a natural polymer or synthetic polymer may be mixed in the jetting solution as aforementioned in order to adjust the viscosity of the jetting solution. In the case of patterning in a sequential jet method, it is desirable that the jetting solution has a viscosity of 1000 cP or more, and a natural polymer or synthetic polymer may be mixed in the jetting solution as aforementioned in order to adjust the viscosity of the jetting solution.

Herein, instead of Indium Oxide, the jetting solution may include at least one of a metal material, an organic conductive material, or an inorganic conductive material, and, more preferably, at least one of Au, Ag, Ag nano wire, Al, Cu, carbon nano tube (CNT), Graphene and Polyethylenedioxythiophene (PEDOT), and a group of combinations thereof.

The method may further include forming a third connecting pattern (S135) of patterning a third connecting pattern 123 to be connected from the first electrodes 111 provided in a leftmost or rightmost to the touch controller 140 and connected from a lowermost of the second electrodes 112 to the touch controller 140. The forming of a third connecting pattern (S135) is the same as the method of patterning the second connecting pattern 122 at the step of forming a second connecting pattern (S130) in the case of patterning in an electrohydrodynamic (EHD) ink jetting type, and therefore detailed explanation thereof is omitted. However, when the line width of the third connecting pattern 123 is patterned to 50 μm or less, it becomes possible to minimize a bezel area of an electronic apparatus using a touch screen panel 100 according to a first exemplary embodiment of the present disclosure (S100). More desirably, it becomes possible to pattern the line width of the third connecting pattern 123 to 10 μm or less and manufacture a touch screen panel having almost no bezel area.

However, the third connecting pattern 123 is not patterned only in an electrohydrodynamic (EHD) ink jetting type, but may be patterned in at least one of a lithography type, gravure printing type, offset printing type, gravure-offset printing type, or flexo printing method.

With reference to FIG. 7, a method for manufacturing a touch screen panel according to a first exemplary embodiment of the present disclosure (S100) may be patterned sequentially by a roll process. A substrate where the basic pattern is formed is transferred along the second direction, that is along the direction in which the second connecting pattern 122 is to be patterned, and a jetting solution is jetted from the first fixed nozzle 310 so as to perform the step of forming insulating layers (S120) of forming the insulating layers 130 on the substrate which is transferred to a lower side of the first fixed nozzle 310 disposed on the direction in which the substrate is transferred. The first fixed nozzle 310 jets the jetting solution in an electrohydrodynamic (EHD) ink jetting type, that is, one of a drop-on-demand type or sequential jet type.

The substrate where a basic pattern is patterned to the insulating layers is continuously transferred and passes a lower side of the second fixed nozzle disposed to be distanced from the first fixed nozzle 310 in an opposite direction to the direction in which the substrate is transferred. The step of forming a second connecting pattern (S130) is performed where the second connecting pattern 122 is patterned by the jetting solution being jetted from the second fixed nozzle 320. The second fixed nozzle 320 jets the jetting solution in an electrohydrodynamic (EHD) ink jetting type, that is, one of a drop-on-demand type or sequential jet type.

That is, a touch screen panel is continuously manufactured in the roll process system where the first fixed nozzle 310 and second fixed nozzle 320 are provided and are transferred by the roll, thereby reducing the processing time.

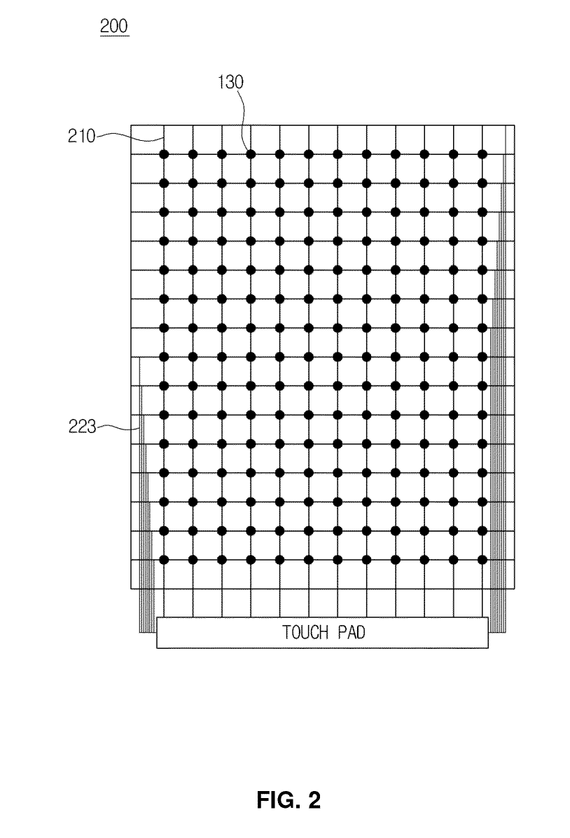

Next is explanation on a method for manufacturing a touch screen panel according to a second exemplary embodiment of the present disclosure (S200). First of all, hereinbelow is explanation on a touch screen panel 200 manufactured by a second exemplary embodiment of the present disclosure (S100). FIG. 2 is a top view roughly illustrating a touch screen panel manufactured by a method for manufacturing a touch screen panel according to a second exemplary embodiment of the present disclosure. With reference to FIG. 2, a touch screen panel 200 manufactured by a second exemplary embodiment of the present disclosure (S100) includes electrodes 210, third connecting pattern 123, insulating layers 130, and touch controller 140.

An electrode 210 is an element for recognizing a touch. The electrodes 210 include a plurality of first electrodes 211 disposed horizontally to neighbor one another and a plurality of second electrodes 212 disposed vertically to neighbor one another.

Herein, the first electrodes 211 or second electrodes 121 includes at least one material of among a metal material, an inorganic conductive material, and an organic conductive material, preferably, at least one material selected from a group consisting of Au, Ag, Ag nano wire, Al, Cu, CNT, Graphene, conductive high molecule PEDOT, or a combination thereof. However, other than the electrodes in the first exemplary embodiment of the present disclosure, in the second exemplary embodiment (S200), the electrodes 210 comprise a plurality of straight lines. In addition, in the second exemplary embodiment, there are no first connecting pattern 121 or second connecting pattern 122 that connects each of the first electrodes 111 or second electrodes in the first exemplary embodiment 100. In other words, the first electrodes 211 in the second exemplary embodiment 200 is a combination of the first electrodes 111 and first connecting pattern 121 of the first exemplary embodiment 100, and the second electrodes 212 in the second exemplary embodiment 200 is a combination of the second electrodes 112 and second connecting pattern 122 of the first exemplary embodiment 100. Thus, the first electrodes 211 and second electrodes 212 are all formed in straight lines.

In addition, it is desirable that each of the first electrodes 211 or second electrodes 212 has a line width of 10 μm or less that cannot be recognized visually by human sight. If the electrodes are patterned to have line widths of 10 μm or less and, thus, cannot be recognized visually by human sight, it becomes possible to prevent a phenomenon where the pattern of the electrodes 210 is seen from outside.

The third connecting pattern 223 is the same as in the first exemplary embodiment 100 and, thus, detailed explanation is omitted.

The case of insulating layers 130 is also the same as in the first exemplary embodiment 100 and, therefore, a detailed explanation is omitted. However, in the second exemplary embodiment 200, the first electrodes 211 and the second electrodes 212 are patterned to have straight lines of 10 μm or less, and, therefore, it becomes possible to prevent a phenomenon where the pattern of the insulating layers 130 is seen from outside.

The case of the touch controller 140 is the same as in the first exemplary embodiment 100, and, therefore, a detailed explanation is omitted. That is, a touch screen panel according to the second exemplary embodiment 200 has a shape similar to a checkerboard, but, because the first electrodes 211 or the second electrodes 212 are patterned to have line widths of 10 μm, they cannot be seen by human sight. In addition, the insulating layers 130 are also patterned in dots, making it difficult to be seen by human sight, thereby preventing a phenomenon where the pattern of the touch screen panel is seen from outside.

Hereinbelow is explanation on a manufacturing method of a touch screen panel according to the second exemplary embodiment (S200).

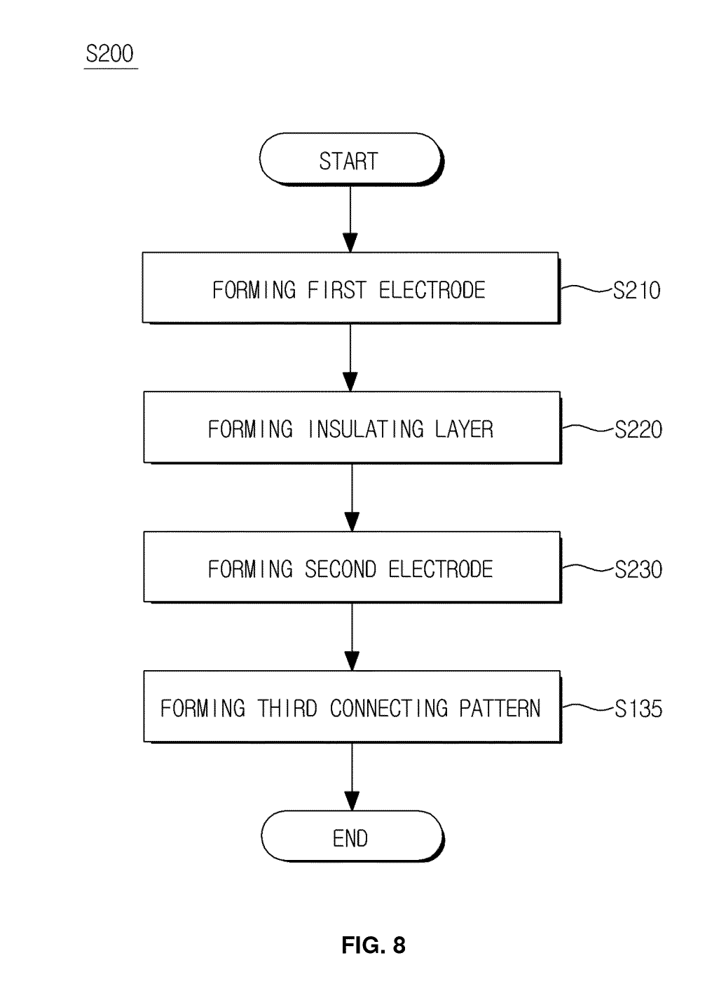

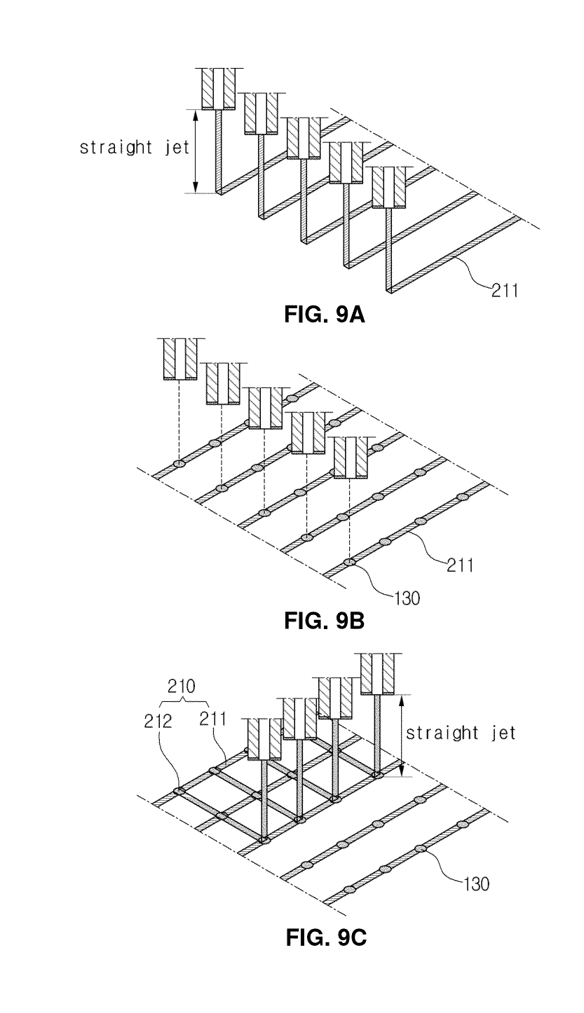

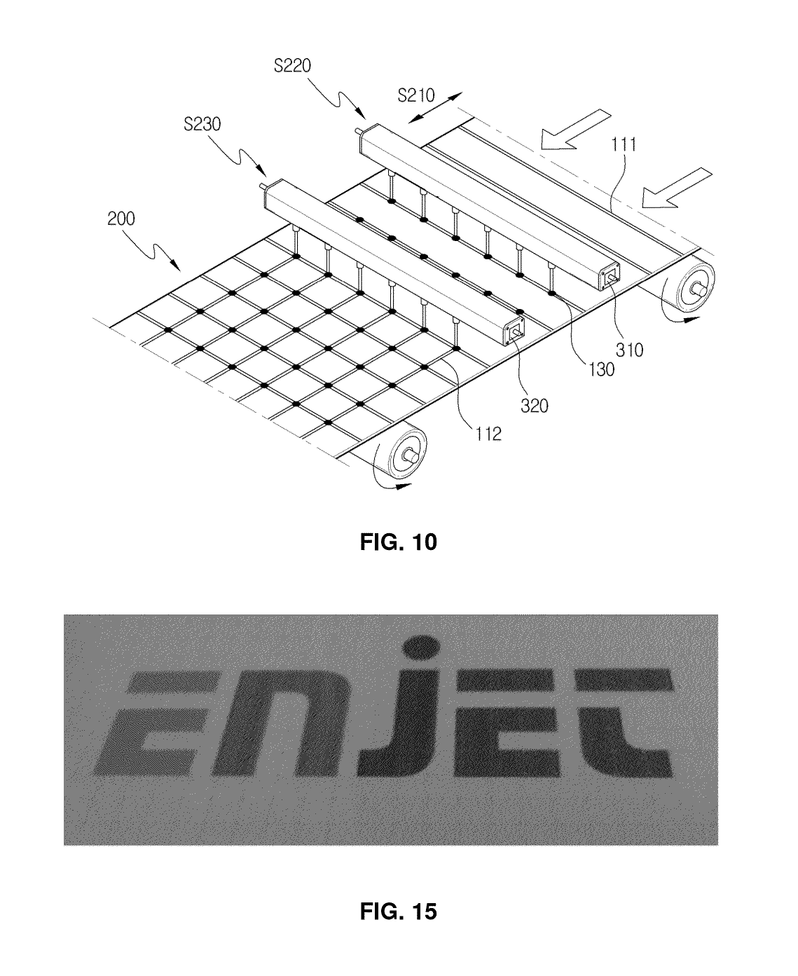

FIG. 8 is a flowchart roughly illustrating a method for manufacturing a touch screen panel according to the second exemplary embodiment of the present disclosure. FIGS. 9A to 9C are perspective views roughly illustrating a method for manufacturing a touch screen panel according to a second exemplary embodiment, where FIG. 9A is a perspective view of patterning first electrodes, FIG. 9B is a perspective view of patterning insulating layers over the first electrodes, FIG. 9C is a perspective view of patterning a second connecting pattern over the insulating layers, and FIG. 10 is a perspective view roughly illustrating a method for manufacturing a touch screen panel.

With reference to FIGS. 8 and 9, a method for manufacturing a touch screen panel according to a second exemplary embodiment of the present disclosure (S200) includes forming first electrodes (S210), forming insulating layers (S220), and forming second electrodes (S230). The forming first electrodes (S210) is a step of forming a plurality of first electrodes 211 disposed to neighbor one another in a horizontal direction. They are patterned in an electrohydrodynamic (EHD) ink jetting type, and, more particularly, in one of a drop-on-demand type or sequential jet type. In the case of patterning the first electrodes in a drop-on-demand type, it is desirable that a jetting solution has a viscosity of 1000 cP or less, and, in order to adjust the viscosity of the jetting solution, a natural polymer or synthetic polymer may be mixed in the jetting solution as aforementioned. In the case of patterning the first electrodes in a sequential jet type, it is desirable that a jetting solution has a viscosity of 1000 cP or more, and, in order to adjust the viscosity of the jetting solution, a natural polymer or synthetic polymer may be mixed in the jetting solution as aforementioned. In order to adjust the viscosity of the jetting solution, a natural polymer or synthetic polymer may be mixed therein. Herein, the natural polymer comprises at least one of, but is not limited to, chitosan, gelatin, collagen, elastin, hyaluronic acid, cellulose, silk fibroin, phospholipids, and fibrinogen, or a combination thereof.

In addition, the synthetic polymer comprises at least one of but is not limited to PLGA(Poly(lactic-co-glycolic acid)), PLA(Poly(lactic acid)), PHBV(Poly(3-hydroxybutyrate-hydroxyvalerate), PDO(Polydioxanone), PGA(Polyglycolic acid), PLCL(Poly(e-caprolactone-co-lactide)), PCL(Poly(e-caprolactone)), PLLA(Poly-L-lactic acid), PEUU(Poly(ether Urethane Urea), Cellulose acetate), PEG(Polyethylene glycol), EVOH(Poly(Ethylene Vinyl Alcohol), PVA(Polyvinyl alcohol), PEO(Polyethylene glycol) and PVP(Polyvinylpyrrolidone), or a combination thereof.

It is desirable that each of the first electrodes 211 is patterned to have a line width of 10 μm or less, so as not to be visually recognizable from outside (that is, to prevent a phenomenon of the pattern being seen from outside).

It is desirable that, at the step of forming first electrodes (S210), the first electrodes 211 are simultaneously formed using a plurality of dischargers distanced from one another at a certain distance so as to pattern the first electrodes to be distanced from one another a certain distance.

In addition, it is desirable that the jetting solution used in patterning the first electrodes 211 is selected from Au, Ag, Ag nano wire, Al, Cu, carbon nano tube (CNT), Graphene and Polyethylenedioxythiophene (PEDOT), or a group of combination thereof, instead of Indium.

The forming insulating layers (S220) is the same as the step of forming insulating layers of the first exemplary embodiment (S100) and, therefore, a detailed explanation is omitted. However, since the first electrodes 211 do not form polygonal shapes but straight lines, it is easier to pattern the first electrodes 211 in a pattern by dots or patterns of micro or nanometer scale areas, and minimize the size of the insulating layers 230.

The forming second electrodes (S230) is a step of patterning a plurality of second electrodes 212 disposed to neighbor one another in a vertical direction. The second electrodes 212 are patterned in the same way as the first electrodes 211. However, to prevent contact with the first electrodes 211, the second electrodes 212 are patterned to pass over the insulating layers 230 patterned at the step of forming insulating layers (S220).

In addition, the second exemplary embodiment (S200) may also include the forming a third connecting pattern (S135). The forming a third connecting pattern (S135) is the same as in the first exemplary embodiment (S100), and, therefore, a detailed explanation is omitted.

With reference to FIG. 10, a method for manufacturing a touch screen panel according to the second exemplary embodiment of the present disclosure may perform the patternings sequentially by a roll process. A substrate where the basic pattern is formed is transferred along the second direction, that is, along the direction in which the second connecting pattern 122 is to be patterned, and a jetting solution is jetted from the first fixed nozzle 310 so as to perform the step of forming insulating layers (S120) of forming the insulating layers 130 on the substrate which is transferred to a lower side of the first fixed nozzle 310 disposed on the direction in which the substrate is transferred. The first fixed nozzle 310 jets the jetting solution in an electrohydrodynamic (EHD) ink jetting type, that is, one of a drop-on-demand type or sequential jet type.

The substrate where a basic pattern is patterned to the insulating layers is continuously transferred, and passes a lower side of the second fixed nozzle 320 disposed to be distanced from the first fixed nozzle 310 in an opposite direction to the direction in which the substrate is transferred. The step of forming a second connecting pattern (S130) is performed where the second connecting pattern 122 is patterned by the jetting solution being jetted from the second fixed nozzle 320. The second fixed nozzle 320 jets the jetting solution in an electrohydrodynamic (EHD) ink jetting type, that is, one of a drop-on-demand type or sequential jet type. In other words, a touch screen panel is continuously manufactured in the roll process system where the first fixed nozzle 310 and second fixed nozzle 320 are provided and are transferred by the roll, thereby reducing the processing time.

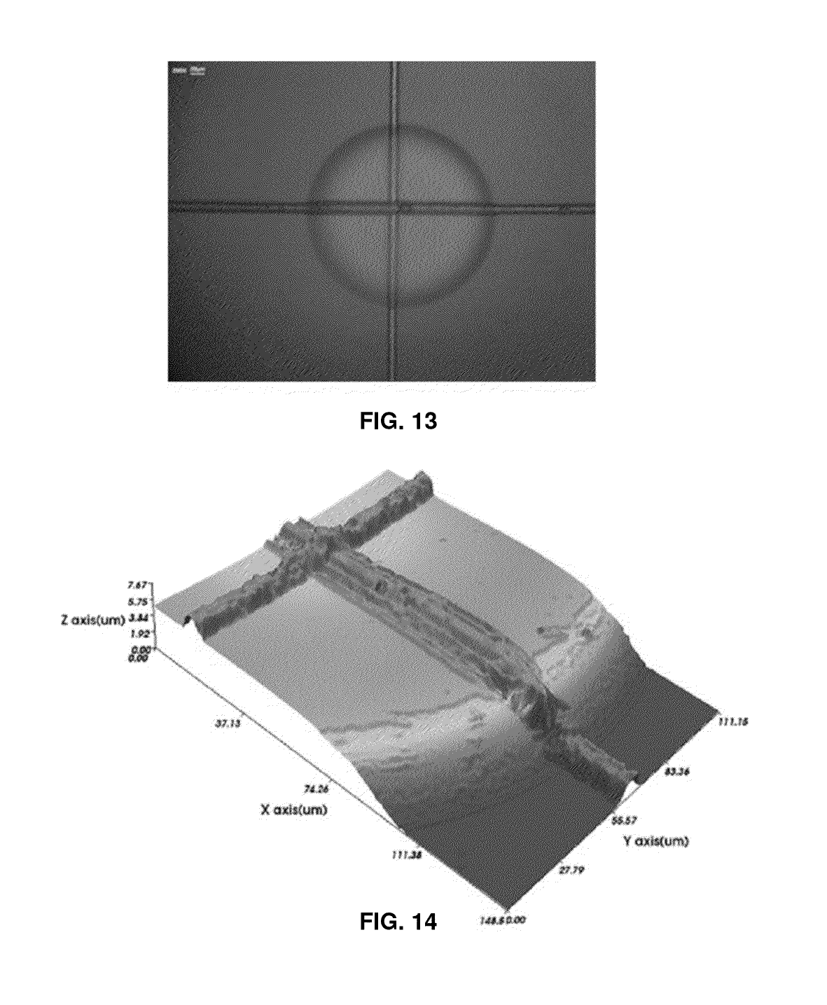

FIGS. 13 to 15 provide the overall configuration of a touch screen panel 200 manufactured by the second exemplary embodiment of the present disclosure (S200). FIG. 13 is a plan view roughly illustrating a touch screen panel manufactured by the second exemplary embodiment of the present disclosure. FIG. 14 is a perspective view roughly illustrating a touch screen panel manufactured by the second exemplary embodiment of the present disclosure. FIG. 15 is a photograph where a touch screen panel manufactured by a second exemplary embodiment of the present disclosure is provided over letters. FIGS. 13 and 14 show the first electrodes 211, insulating layers 230 formed in circles, and second electrodes 212 sequentially deposited in the aforementioned order. FIG. 15 is a photograph where a touch screen panel manufactured by the second exemplary embodiment of the present disclosure is provided over the letters ‘Enjet’. It can be seen that the patterns of the touch screen panel manufactured by the second exemplary embodiment of the present disclosure are not visually recognizable.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for manufacturing a touch screen panel, which comprises:
forming a basic pattern of patterning first electrodes along a first direction on a substrate, second electrodes along a second direction crossing the first direction, and a first connecting pattern connecting the first electrodes;
forming insulating layers of patterning insulating layers over the first connecting pattern; and
forming a second connecting pattern of patterning a second connecting pattern in an electrohydrodynamic (EHD) ink jetting type such that the second connecting pattern connecting the second electrodes passes over the insulating layers.

2. The method according to claim 1, which further comprises forming a third connecting pattern of patterning the third connecting pattern connecting one of the first electrodes and the second electrodes with a touch controller for transmitting signal information generated in the one of the first electrodes and the second electrodes, after the forming the basic pattern.

3. The method according to claim 2, wherein:
the electrohydrodynamic (EHD) ink jetting type is one of a drop-on-demand type of patterning by jetting a jetting solution in liquid droplets and a sequential jet type of patterning by sequential jetting through electrospinning of the jetting solution; and
one of the second connecting pattern the third connecting pattern is patterned by the sequential jet type or the drop-on-demand type.

4. The method according to claim 3, wherein the jetting solution having a viscosity of 1000 cP or less is used to pattern the insulating layers between the first connecting pattern and second connecting pattern by dots or patterns of micro or nanometer scale areas preventing contact between the first connecting pattern and second connecting pattern.

5. The method according to claim 2, wherein the third connecting pattern is patterned to have a line width of 50 μm or less.

6. The method according to claim 1, wherein a jetting solution used in patterning the second connecting pattern is at least one of a metal material, an inorganic conductive material, and an organic conductive material.

7. The method according to claim 6, wherein a material of the jetting solution comprises at least one of Au, Ag, Ag nano wire, Al, Cu, carbon nano tube (CNT), Graphene and Polyethylenedioxythiophene (PEDOT).

8. The method according to claim 7, wherein:
the jetting solution further comprises one of a natural polymer and a synthetic polymer so as to adjust a viscosity of the jetting solution;
the natural polymer comprises at least one of chitosan, gelatin, collagen, elastin, hyaluronic acid, cellulose, silk fibroin, phospholipids, and fibrinogen; and
the synthetic polymer comprises at least one of PLGA(Poly(lactic-co-glycolic acid)), PLA(Poly(lactic acid)), PHBV(Poly(3-hydroxybutyrate-hydroxyvalerate), PDO(Polydioxanone), PGA(Polyglycolic acid), PLCL(Poly(e-caprolactone-co-lactide)), PCL(Poly(e-caprolactone)), PLLA(Poly-L-lactic acid), PEUU(Poly(ether Urethane Urea), Cellulose acetate), PEG(Polyethylene glycol), EVOH(Poly(Ethylene Vinyl Alcohol), PVA(Polyvinyl alcohol), PEO(Polyethylene glycol) and PVP(Polyvinylpyrrolidone).

9. The method according to claim 1, wherein:
the substrate where the basic pattern is formed is transferred along the second direction;
at the forming insulating layers, the insulating layers are patterned by a jetting solution being jetted from a first fixed nozzle disposed in the direction the substrate is transferred on the substrate;
at the forming the second connecting pattern, the second connecting pattern is patterned by the jetting solution being jetted from a second fixed nozzle disposed to be distanced from the first fixed nozzle in an opposite direction to the direction the substrate is transferred; and
the insulating layers and second connecting pattern are sequentially patterned by a roll process.

10. The method according to claim 2, wherein:
the substrate where the basic pattern is formed is transferred along the second direction;
at the forming insulating layers, the insulating layers are patterned by a jetting solution being jetted from a first fixed nozzle disposed in the direction the substrate is transferred on the substrate;
at the forming the second connecting pattern, the second connecting pattern is patterned by the jetting solution being jetted from a second fixed nozzle disposed to be distanced from the first fixed nozzle in an opposite direction to the direction the substrate is transferred; and
the insulating layers and second connecting pattern are sequentially patterned by a roll process.

11. A method for manufacturing a touch screen panel, which comprises:
forming first electrodes of patterning a plurality of first electrodes to be distanced from one another along a first direction by an electrohydrodynamic (EHD) ink jetting type;
forming insulating layers of patterning a plurality of insulating layers to be distanced from one another along the first electrodes by an electrohydrodynamic (EHD) ink jetting type; and
forming second electrodes wherein the plurality of first electrodes are distanced from one another along the first direction by an electrohydrodynamic (EHD) ink jetting type.

12. The method according to claim 11, which further comprises forming a third connecting pattern of patterning the third connecting pattern connecting one of the first electrodes and the second electrodes with a touch controller for transmitting signal information generated in the one of the first electrodes and the second electrodes, after the forming second electrodes.

13. The method according to claim 12, wherein:
the electrohydrodynamic (EHD) ink jetting type is one of a drop-on-demand type of patterning by jetting a jetting solution in liquid droplets and a sequential jet type of patterning by sequential jetting through electrospinning of the jetting solution; and
at least one of the first electrodes, the second electrodes, and the third connecting pattern are patterned by the one of the sequential jet type and the drop-on-demand type.

14. The method according to claim 3, wherein the jetting solution having a viscosity of 1000 cP or less is used to pattern the insulating layers between the first electrodes and second electrodes by one of dots and patterns of one of micro and nanometer scale areas preventing contact between the first electrodes and the second electrodes.

15. The method according to claim 12, wherein the third connecting pattern is patterned to have a line width of 50 μm or less.

16. The method according to claim 15, wherein at least one of the first electrodes, the second electrodes and the third connecting pattern are patterned to have a line width of 10 μm or less.

17. The method according to claim 16, wherein a jetting solution used in patterning at least one of the first electrodes and the second electrodes is at least one of a metal material, an inorganic conductive material, and an organic conductive material.

18. The method according to claim 17, wherein a material of the jetting solution comprises at least one of Au, Ag, Ag nano wire, Al, Cu, carbon nano tube (CNT), Graphene, and Polyethylenedioxythiophene (PEDOT).

19. The method according to claim 18, wherein:
the jetting solution further comprises one of a natural polymer and a synthetic polymer so as to adjust a viscosity of the jetting solution;
the natural polymer comprises at least one of chitosan, gelatin, collagen, elastin, hyaluronic acid, cellulose, silk fibroin, phospholipids, and fibrinogen; and
the synthetic polymer comprises at least one of PLGA(Poly(lactic-co-glycolic acid)), PLA(Poly(lactic acid)), PHBV(Poly(3-hydroxybutyrate-hydroxyvalerate), PDO(Polydioxanone), PGA(Polyglycolic acid), PLCL(Poly(e-caprolactone-co-lactide)), PCL(Poly(e-caprolactone)), PLLA(Poly-L-lactic acid), PEUU(Poly(ether Urethane Urea), Cellulose acetate), PEG(Polyethylene glycol), EVOH(Poly(Ethylene Vinyl Alcohol), PVA(Polyvinyl alcohol), PEO(Polyethylene glycol) and PVP(Polyvinylpyrrolidone).

20. The method according to claim 11, wherein:
an electrode where the first electrodes are patterned is transferred along a second direction crossing the first direction;
at the forming insulating layers, the insulating layers are patterned by a jetting solution being jetted from a first fixed nozzle disposed along the direction a substrate is transferred on the substrate;
at the forming second electrodes, the second electrodes are patterned by the jetting solution being jetted from a second fixed nozzle disposed to be distanced from the first fixed nozzle in an opposite direction to the direction the substrate is transferred; and
the insulating layers and second electrodes are sequentially patterned by a roll process.
